(19) United States
(12) Patent Application Publication
(10) Pub. No.: US 2005/0088258 A1
(43) Pub. Date: Apr. 28, 2005

(54) Millimeter wave surface mount filter

(75) Inventor: Eugene Fischer, Clermont, FL (US)

Correspondence Address: RICHARD K. WARTHER;ALLEN, DYER,DOPPELT,MILBRATH & GILCHRIST P.A., 1401 CITRUS CENTER 255 SOUTH ORANGE AVENUE, P.O. BOX 3791, ORLANDO, FL, 32802-3791, US

(73) Assignee: Xytrans, Inc., Orlando, FL (US)

(21) Appl. No.: 10/694,523

(22) Filed: Oct. 27, 2003

(51) Int. Cl. H01P 1/203

(52) U.S. Cl. 333/204

(57) ABSTRACT

A millimeter wave filter for surface mount applications includes at least one low temperature, co-fired ceramic layer defining an outer filter surface. A plurality of parallel, coupled line millimeter wavelength hairpin resonators, each formed from a single stripline or microstrip, are positioned on the outer filter surface. Each hairpin resonator is folded back upon itself into substantially parallel resonator lines.

### FIELD OF THE INVENTION

This invention relates to the field of millimeter wave filters, and more particularly, this invention relates to millimeter wave filters, such as parallel coupled line filters formed as hairpin filters.

### BACKGROUND OF THE INVENTION

Almost every high frequency, RF module manufactured today requires a number of filters, including millimeter wave filters. For example, a transceiver will typically have an image reject filter and one local oscillator (LO) reject filter. The estimated number of RF modules built worldwide, including cell phones, is now over 600 million.

Traditionally, high performance filters at frequencies greater than 800 MHz for use in millimeter wavelength applications are designed and fabricated using dielectric resonators. Tight design and manufacturing tolerances are required to achieve a desired filter response at these high frequencies. The filter length and width usually varies as a function of frequency band, substrate parameters, and performance requirements. These filters are expensive, typically $10 each at the present time, and are usually hand-tuned during fabrication. Conventionally designed parallel, coupled line filters are not practical at and below L-band frequencies because of their large size. A standard three pole, 1.5 GHz hairpin filter is about 800 mils by about 400 mils and printed on an alumina (Er=9.9) substrate.

Commonly assigned U.S. Pat. No. 6,483,404, issued Nov. 19, 2002, the disclosure which is hereby incorporated by reference in its entirety, discloses a high performance, millimeter wave radio frequency filter using standard thick film technology and manufacturing tolerances. The invention disclosed in this '404 patent is an improvement over prior art parallel-coupled line filters where the length of the filter is proportional to the number of poles and RF wavelength, for example, as commonly manufactured using thin film, filter designs.

In the incorporated by reference '404 patent, a high performance, millimeter wave filter uses low temperature, co-fired ceramic thick film technology and is operative as a high “Q” filter. This filter is small and can include vertically stacked resonators positioned in a multilayer, low temperate co-fired ceramic film allowing even smaller designs. The disclosed resonators can form parallel, coupled line filters, including a hairpin filter formed by a number of hairpin resonators cascaded together. In one aspect of the '404 patent, microstrip and stripline interface connections are used to stack the filters in the low temperature co-fired ceramic layers, allowing the filter to be used for standard surface mount packages. The filters are desensitized to traditional critical tolerances associated with thin film technology and compensate for bandwidth and return loss degradation caused by wider tolerances associated with thick film technology. These type of filters disclosed in the incorporated by reference '404 patent can be manufactured for high performance capabilities at a fraction of the cost of thin film filters. Additionally, these types of filters, including hairpin filters, can eliminate filter size variation versus frequency and reduce the size of the filter by 50%.

In another aspect of the disclosed '404 patent, the millimeter wave filter includes a dielectric base plate having opposing surfaces. A ground plane layer is formed on a surface of the dielectric base plate. At least one low temperature, co-fired ceramic layer is positioned over the ground plane layer and defines an outer filter surface. A plurality of coupled line millimeter wavelength resonators, such as parallel coupled resonators, including hairpin resonators, are formed as stripline or microstrip and positioned on the outer filter surface.

Radio frequency terminal contacts are positioned on the surface of the dielectric base plate opposite the at least one low temperature co-fired ceramic layer. Conductive vias extend through the at least one low temperature co-fired ceramic layer, ground plane and dielectric base plate and each interconnect radio frequency terminal contacts and the at least one coupled line resonator.

Hairpin filters are advantageously used and have been typically about half the size of traditional parallel-coupled line filters. A hairpin filter allows size reduction from a parallel-coupled line structure. A filter of this type usually is a cascade of U-shaped resonators. A standard tapped hairpin filter could occupy about 850 mils by 450 mils, including sufficient area beyond the hairpin loops to maintain consistent dielectric properties. Printed hairpin filters can sometimes be excessively large at L-band frequencies and are often replaced with lumped component filters.

### SUMMARY OF THE INVENTION

It is therefore an object of the present invention to provide a millimeter wave, thick film surface mount filter as a hairpin filter with reduced size.

The present invention is a very small, low cost, high performance RF filter using standard thick film technology and manufacturing tolerances. It incorporates a unique, hairpin resonator folded upon itself and manufactured on ceramic material. No other packaging is required. It achieves high radio frequency performance using standard thick film technology while forming a high Q filter in a very small space using folded hairpin resonators. The filter can be designed for a standard surface mount assembly and can achieve high performance filtering that is desensitized to traditional critical tolerance associated with dielectric resonator technology. Thus, in accordance with the present invention, high precision filters can be achieved at a fraction of the cost of dielectric resonator filters and superior performance achieved that is greater than performances achieved with typical SAW filters, including lower insertion losses and lower group delay.

A millimeter wave filter for surface mount applications, in accordance with the present invention, includes at least one low temperature, co-fired ceramic layer defining an outer filter surface. A plurality of parallel, coupled line millimeter wavelength hairpin resonators are each formed from a single stripline or microstrip on the outer filter surface. Each hairpin resonator is folded back upon itself into substantially parallel resonator lines.

In one aspect of the present invention, each hairpin resonator is folded back upon itself into at least six, substantially parallel resonator lines. The at least one low temperature, co-fired ceramic layer can comprise alumina that is about 5 to about 25 mils thick. A ground layer can be formed opposite the outer filter surface. A ground layer can include one of a layer of gold or silver. It can include input and output terminals on a surface opposite the outer filter surface.

A conductive via could extend through the at least one low temperature, co-fired ceramic layer and interconnect respective input and output terminals and a hairpin resonator. The hairpin resonators that are folded back upon themselves could form a millimeter wave filter that is about 320 mil by about 320 mil.

In yet another aspect of the present invention, a plurality of low temperature, co-fired ceramic layers and interposed ground plane layers form a multilayer, low temperature, co-fired ceramic substrate board. A plurality of millimeter wavelength hairpin resonators are formed on the ceramic layers and each folded back upon themselves into parallel resonator lines. A dielectric cover is positioned over the outer filter surface and can include a metallized interior surface spaced from the resonators for generating a predetermined cut-off frequency.

### BRIEF DESCRIPTION OF THE DRAWINGS

Other objects, features and advantages of the present invention will become apparent from the detailed description of the invention, which follows when considered in light of the accompanying drawings in which:

FIG. 1 is a fragmentary, plan view of a low temperature, co-fired ceramic (LTCC) filter disclosed in the incorporated by reference '404 patent that could be modified for use with the present invention.

FIG. 2 is a fragmentary, sectional view of the filter shown in FIG. 1, and formed with an alumina carrier plate, a layer of low temperature co-fired ceramic tape, and a ground layer.

FIG. 3 is a fragmentary, bottom plan view of the filter shown in FIG. 1.

FIG. 4 is a fragmentary, plan view of a multilayer six-pole filter that is created by cascading three, two-pole filters in different LTCC layers, which could be modified for use with the present invention.

FIG. 5 is a fragmentary, sectional view of the filter of FIG. 4 and showing stacked low temperature co-fired ceramic layers.

FIG. 6 is a fragmentary, bottom plan view of the filter shown in FIG. 4.

FIG. 7 is a plan view of the filters of the present invention that could be formed by modifying structures shown in FIGS. 1-6, and showing hairpin resonators folded upon themselves.

FIGS. 8A and 8B are plan views looking from the top and bottom of a surface mount package configuration of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention advantageously provides a small, low cost, high performance, millimeter wave RF filter using standard thick film technology and manufacturing tolerances. The high performance filter of the present invention is designed with unique hairpin resonators that are folded upon themselves and manufactured on ceramic material, such as LTCC. No other packaging is required. It achieves high RF performance using standard thick film technology, while achieving a high Q in a small space. The filter of the present invention can be designed for standard surface mount assembly and desensitized to traditional critical tolerances associated with dielectric resonator technology. The present invention provides a high performance filter at a fraction of the cost of a dielectric resonator filter and achieves superior performance as compared to SAW filters, including lower insertion losses and lower group delay.

The present invention has the arms of each of the hairpin resonators of a hairpin filter folded upon themselves to reduce the overall size significantly. The length of the hairpin resonators in a hairpin filter in one aspect of the present invention is a quarter wavelength long at the design frequency. A fractional bandwidth of the narrow band filter is less than 1.5% and it takes more time to synthesize than on regular filters. The filters can be successfully fabricated on etched thick film alumina substrate with excellent performance.

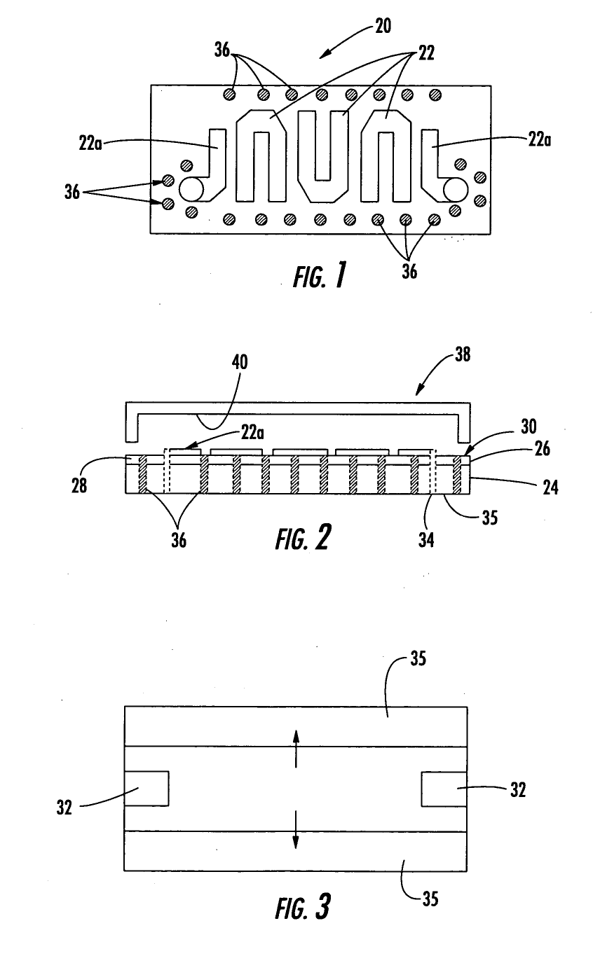

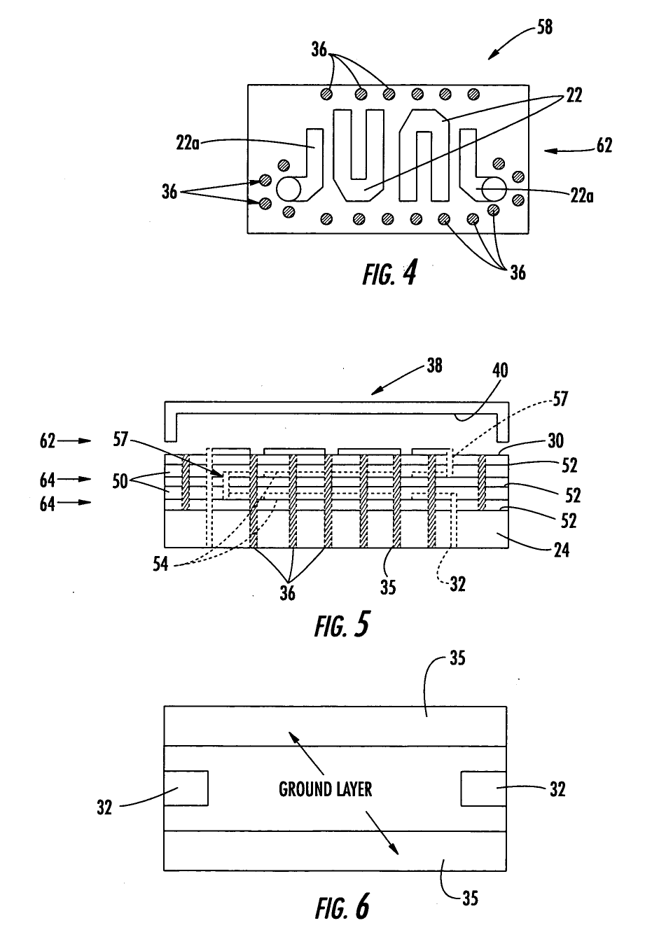

For purposes of background, a description of a millimeter wave filter for surface mount applications that uses at least one low temperature co-fired ceramic layer and coupled line, millimeter wavelength resonators formed from stripline or microstrip and positioned on an outer filter surface are described relative to FIGS. 1-6, which correspond to the disclosure of FIGS. 4-9 in the incorporated by reference '404 patent. The structures shown in FIGS. 1-6 can be modified for use with the present invention. Hairpin resonators folded upon themselves can be formed on the filter surface.

Referring now to FIGS. 1-3, there is illustrated a hairpin filter structure as a surface mount package, using thick film, low temperature co-fired ceramic materials. FIG. 1 shows an exemplary hairpin filter formed as a two-pole filter 20 with individual hairpin resonators 22. The filter uses an alumina carrier plate 24 that is about 25 mil thick, in one non-limiting example, and acts as a dielectric base plate having opposing surfaces. A ground plane layer 26 is formed on a surface of the dielectric base plate 24. A low temperature co-fired ceramic layer 28 is positioned over the ground plane layer 26 and defines an outer filter surface 30. This low temperature co-fired ceramic layer 28 can be formed of a layer of low temperature co-fired ceramic tape 28, which could also be Low Temperature Transfer Tape (LTTT) formed as green tape. In this illustrated aspect, it is formed about 5 to about 7 mils thick with a ground plane layer separating the dielectric base plate and the green tape layer.

A plurality of coupled line millimeter wavelength hairpin resonators 22 are formed as either stripline or microstrip and positioned on the outer filter surface 30. Radio frequency terminal contacts 32 are positioned on the surface of the dielectric base plate opposite the low temperature co-fired ceramic layer 28 formed from the green tape. As illustrated, conductive vias 34 extend through the low temperature co-fired ceramic layer 28, ground plane layer 26, and dielectric base plate, i.e., carrier plate 24, and each interconnect the radio frequency terminal contacts 32 (FIG. 3) and the end positioned coupled line resonators 22a formed on the outer filter surface 30.

The dielectric base plate is formed about 10 to about 35 mils thick (and preferably in one aspect about 25 mils thick) and formed from alumina, also known as aluminum oxide, a well-known ceramic dielectric material. Other dielectric materials could be used as suggested by those skilled in the art.

As shown in FIG. 2, a lower ground plane layer 35 can be positioned on the surface of the dielectric base plate 24 opposite the upper positioned ground plane layer 26 and the green tape layer 28 and isolated from the radio frequency terminal contacts as illustrated by the two parallel formed lines. A plurality of isolation vias 36 extend through the low temperature co-fired ceramic (green tape) layer 28 and dielectric base plate 24 and substantially engage the parallel strips forming the lower ground plane layer 35. As shown in FIG. 1, the isolation vias 36 isolate the hairpin filter formed by hairpin resonators. A dielectric cover 38 can be positioned over the outer filter surface 30. This cover 38 has a metallized interior surface 40, such as formed from gold layer or similar material, that is spaced from the hairpin resonators 22 for generating a predetermined cut-off frequency. This cover 38 also shields the formed filter from outside interference. The distance between the microstrip and the top of the cover is about 20 mils, but can vary depending on what is required by one skilled in the art. If a filter is made of stripline only, a cover 38 will not usually be required.

In FIGS. 4-6, a plurality of green tape layers 50 are formed as low temperature co-fired ceramic layers and positioned over a first ground plane layer. Intervening ground plane layers 52 are positioned between green tape layers 50. This plurality of low temperature co-fired ceramic layers 50 that are formed as green tape and the interposed ground plane layers 52 form a multilayer low temperature co-fired ceramic substrate board. A plurality of millimeter wavelength, stripline hairpin resonators 54 are formed on the ceramic layers 50 between the outer filter 30 surface and the dielectric base (carrier) plate 24 and isolated by the interposed ground plane layers 52. As illustrated, conductive vias 57 interconnect the hairpin resonators 56 formed on the ceramic layers and outer filter surface. This configuration illustrates a multilayer, six-pole filter 58, which is created by cascading three two-pole filters in three different layers, with one microstrip filter 62 and two stripline filters 64, as illustrated.

These filters described relative to FIGS. 1-6 can have a nominal size of about 150 mil by about 100 mil and can be fabricated on large, six inch single layer or multilayer wafers and cut to size with an appropriate laser. The alumina cover 38 having the metallized interior surface can be attached to the filter using conductive silver epoxy. Where the top filter resonators are made of stripline only, a cover will not be required.

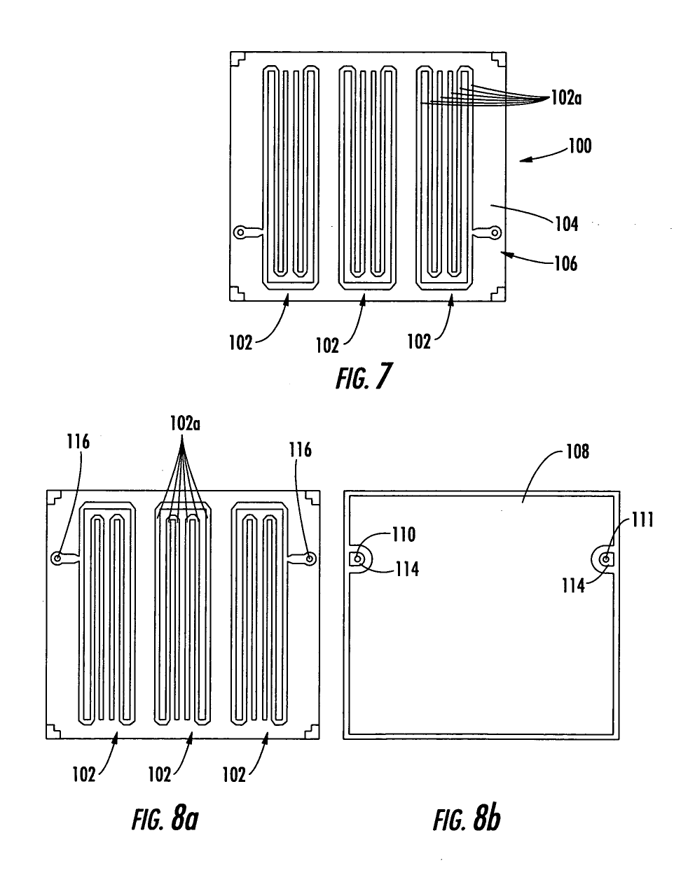

FIGS. 7 and 8 illustrate a filter of the present invention, showing a hairpin filter 100 and formed from hairpin resonators 102. The hairpin resonators normally have U-shaped arms as in FIGS. 1-6, but in the present invention, the arms are folded back upon themselves into substantially parallel resonator lines 102a (shown as six substantially parallel resonator lines in this illustrated embodiment). The hairpin resonators 102 can be formed on the top filter surface 104 of at least one dielectric layer(s) 106 in a similar manner as disclosed with reference to FIGS. 1-6.

In the present invention, the arms of each of the hairpin resonators 102 are folded back upon themselves to reduce the overall size significantly as shown in FIG. 7. As should be understood, the length of the hairpin resonators 102 in a hairpin filter is about a quarter wavelength long at the design frequency and the fractional bandwidth of the narrow band filter is less than 1.5%. It takes more time to synthesize than regular filters.

The hairpin filter as shown in FIG. 7 has folded hairpin resonators 102 and the filter measures less than 320 mil by 320 mil. The hairpin filter can be viewed as a parallel, coupled-line filter having cascaded hairpin resonators 102 that are folded back on themselves. In one aspect of the present invention, each hairpin resonator 102 evolved from sections of half-wavelength open microstrips. Further size reduction is possible by further folding a U-shaped microstrip to form pairs of closely coupled lines. The area of a resonator is no more than one-third of a U-shaped resonator.

FIGS. 8A and 8B show a surface mount package configuration where the filter 100 is fabricated on standard 5 to about 25 mil thick aluminum substrate with one layer of thick film gold or silver and one ground silver layer for the ground layer 108 (FIG. 8B) as modified from the structure described relative to FIGS. 1-6. The hairpin resonators are formed on the top surface (FIG. 8A). An input and output 110, 111 can be connected to bottom solder pads 114 using vias 116, as modified from the structure disclosed relative to FIGS. 1-6 and modified for purposes of the present invention.

The hairpin filter 100, as described with reference to FIGS. 7, 8A and 8B, could have a nominal size of about 320 to about 320 mil and could be fabricated on six-inch ceramic wafers. In present terms, the cost of process material is about $30 a wafer and for a filter this size, the cost per unit would be less than $0.10, which is about 100% cheaper than conventional dielectric resonator filters.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

1. A millimeter wave filter for surface mount applications comprising:
at least one low temperature co-fired ceramic layer defining an outer filter surface; and
a plurality of parallel, coupled line millimeter wavelength hairpin resonators formed on the outer filter surface, each formed from a single stripline or microstrip and folded back upon itself into substantially parallel resonator lines.

2. A millimeter wave filter according to claim 1, wherein each hairpin resonator is folded back upon itself into at least six substantially parallel resonator lines.

3. A millimeter wave filter according to claim 1, wherein said at least one low temperature co-fired ceramic layer comprises alumina.

4. A millimeter wave filter according to claim 1, wherein said at least one low temperature co-fired ceramic layer is about 5 to about 25 mils thick.

5. A millimeter wave filter according to claim 1, and further comprising a ground layer formed opposite the outer filter surface.

6. A millimeter wave filter according to claim 5, wherein said ground layer comprises one of a layer of gold or silver.

7. A millimeter wave filter according to claim 1, and further comprising input and output terminals on a surface opposite the outer filter surface.

8. A millimeter wave filter according to claim 7, and further comprising conductive vias extending through the at least one low temperature co-fired ceramic layer and interconnecting respective input and output terminals and a hairpin resonator.

9. A millimeter wave filter according to claim 7, wherein said hairpin resonators folded back upon themselves form a millimeter wave filter that is about 320 mil×320 mil.

10. A millimeter wave filter according to claim 10, and further comprising a plurality of low temperature co-fired ceramic layers and interposed ground plane layers to form a multilayer, low temperature co-fired ceramic substrate board, and a plurality of millimeter wavelength hairpin resonators formed on the ceramic layers and each folded back upon themselves into parallel resonator lines.

11. A millimeter wave filter according to claim 1, and further comprising a dielectric cover positioned over said outer filter surface.

12. A millimeter wave filter according to claim 11, wherein said dielectric cover includes a metallized interior surface spaced from said hairpin resonators for generating a predetermined cut-off frequency.

13. A millimeter wave filter for surface mount applications comprising:
a dielectric base plate having opposing surfaces;
a ground plane layer formed on a surface of the dielectric base plate;
at least one low temperature, co-fired ceramic layer positioned over the ground plane layer and defining an outer filter surface;
a plurality of parallel, coupled line millimeter wavelength hairpin resonators formed on the outer filter surface, each formed from a single stripline or microstrip and folded back upon itself into substantially parallel resonator lines;
radio frequency terminal contacts forming input and output terminals and positioned on the dielectric base plate opposite the at least one low temperature co-fired ceramic layer; and
conductive vias extending through the at least one low temperature co-fired ceramic layer, ground plane layer and dielectric base plate and each interconnecting said radio frequency terminal contacts and a hairpin resonator.

14. A millimeter wave filter according to claim 13, wherein each hairpin resonator is folded back upon itself into at least six substantially parallel resonator lines.

15. A millimeter wave filter according to claim 13, wherein said low temperature co-fired ceramic layers comprise alumina.

16. A millimeter wave filter according to claim 13, wherein said low temperature co-fired ceramic layers are each about 5 to about 25 mils thick.

17. A millimeter wave filter according to claim 13, wherein said ground plane layer comprises one of a layer of gold or silver.

18. A millimeter wave filter according to claim 13, wherein said hairpin resonators folded back upon themselves form a filter that is about 320 mil×320 mil.

19. A millimeter wave filter according to claim 13, and further comprising a plurality of low temperature co-fired ceramic layers and interposed ground plane layers to form a multilayer low temperature co-fired ceramic substrate board, and a plurality of millimeter wavelength hairpin resonators formed on the ceramic layers and each folded back upon themselves into parallel resonator lines.

20. A millimeter wave filter according to claim 13, and further comprising a dielectric cover positioned over said outer filter surface.

21. A millimeter wave filter according to claim 20, wherein said dielectric cover includes a metallized interior surface spaced from said resonators for generating a predetermined cut-off frequency.

22. A method for forming a millimeter wave filter for surface mount applications comprising the steps of:
forming at least one low temperature co-fired ceramic layer having an outer filter surface; and
forming on the outer filter surface a plurality of parallel, coupled line millimeter wavelength hairpin resonators, each formed from a single stripline or microstrip and each folded back upon itself into substantially parallel resonator lines.
